(19) United States
(12) Patent Application Publication
(10) Pub. No.: US 2019/0077195 A1
(43) Pub. Date: Mar. 14, 2019

(54) PNEUMATIC TIRE

(71) Applicant: THE YOKOHAMA RUBBER CO., LTD., TOKYO (JP)

(72) Inventors: Kaoru YASUDA, KANAGAWA (JP); Yoshio UEDA, KANAGAWA (JP)

(21) Appl. No.: 16/185,842

(22) Filed: Nov. 9, 2018

Related U.S. Application Data
(63) Continuation of application No. 13/807,367, filed on Feb. 8, 2013, now abandoned.

(30) Foreign Application Priority Data
Jun. 29, 2010 (JP) 2010-147494
Jun. 29, 2010 (JP) 2010-147498
Oct. 5, 2010 (JP) 2010-225630

(51) Int. Cl. B60C 9/00; B60C 9/20; D07B 1/06

(52) U.S. Cl. CPC B60C 9/0064; B60C 9/0007; B60C 2009/0085; B60C 2009/2074; B60C 2009/0092; B60C 2009/2083; B60C 2009/209; D07B 1/0606; B60C 2009/2077

(57) ABSTRACT

The present invention provides a pneumatic tire by which workability when molding a tire and tire durability performance can be enhanced without increasing tire weight when providing a reinforcing layer formed by aligning a plurality of monofilament steel wires and embedding this plurality of monofilament steel wires in rubber. The pneumatic tire of the present invention includes a reinforcing layer formed by aligning a plurality of monofilament steel wires and embedding said monofilament steel wires in rubber. Each of the monofilament steel wires is provided with twisting around an axis thereof, and a wire surface twisting angle θ with respect to an axial direction of the monofilament steel wires is not less than 1°.

### CROSS-REFERENCE TO RELATED APPLICATIONS

This application is a continuation of U.S. application Ser. No. 13/807,367, filed 8 Feb. 2013, which is the US National Phase of PCT/JP2011/062933 filed 6 Jun. 2011, which claims priority under 35 USC § 119 based on Japanese patent application Nos. 2010-147494 and 2010-147498, both filed on 29 Jun. 2010, and 2010-225630, filed 5 Oct. 2010. The subject matter of each of these priority applications is incorporated by reference herein.

### TECHNICAL FIELD

The present invention relates to a pneumatic tire including a reinforcing layer formed by aligning a plurality of monofilament steel wires and embedding this plurality of monofilament steel wires in rubber. More particularly, the present invention relates to a pneumatic tire by which workability when molding a tire and tire durability performance can be enhanced without increasing tire weight.

### BACKGROUND OF THE INVENTION

Conventionally, steel cords formed by twisting a plurality of filaments have been used as reinforcing cords of belt layers in pneumatic tires. However, with steel cords formed by twisting a plurality of filaments, cord diameter increases due to internal gaps formed between the filaments which leads to a need for a large amount of coating rubber. As a result, thickness of the belt layer increases, and rolling resistance of the pneumatic radial tire tends to increase.

Thus, using monofilament steel wires as the reinforcing cords of the belt layer has been proposed for the purpose of reducing the amount of coating rubber of the belt layer and, thereby, reducing the rolling resistance of the pneumatic tire. With such monofilament steel wires, compared to cases where steel cords are used that are formed by twisting a plurality of filaments together, the thickness of the belt layer can be reduced, which contributes to the reduction in weight of the pneumatic tire.

In this case, in order to sufficiently ensure tire durability performance based on the belt layer that includes the monofilament steel wires, it is necessary to sufficiently increase the strength of the monofilament steel wires by wire drawing. However, in monofilament steel wires that have been wire drawn, metal material closer to the wire surface side (which is close to the drawing die) is subjected to excessive orientation. Therefore, if these monofilament steel wires are used as-is as the reinforcing cords of a belt layer, there will be problems in that fatigue resistance of the monofilament steel wires will be poor, and the tire durability performance will decline. Additionally, in cases where the monofilament steel wires are used in the belt layer, the monofilament steel wire pulled from a reel when molding a tire will tend to curve, and straightness will be poor. Therefore, there is a problem in that workability when calendering a belt member in which the monofilament steel wires are embedded or when cutting the belt member is poor.

In order to resolve these problems, preforming the monofilament steel wires with, for example, a spiral shape has been proposed (e.g. see Patent Documents 1 to 3). However, in cases where preformed monofilament steel wires are used, compared to cases where monofilament steel wires that have not been preformed are used, the thickness of the belt layer increases, the effect of reducing the weight of the pneumatic tire declines, and the effects of reducing the rolling resistance of the pneumatic tire are inhibited.

Additionally, in cases where monofilament steel wires are used as the reinforcing cords in a belt layer, in order to ensure overall strength of the belt layer, the monofilament steel wires must be disposed in the belt layer at a relatively high wire density. As a result, if cord spacing in the belt layer is too narrow and belt-edge-separation occurs, this belt-edge-separation will easily be propagated throughout a wide range on the tire circumference. Therefore, in cases where monofilament steel wires are used in the belt layer, failures caused by belt-edge-separation are prone to occur, and these failures lead to a decline in the tire durability performance.

### PRIOR ART DOCUMENTS

### Patent Documents

Patent Document 1: Japanese Unexamined Patent Application Publication No. H08-300905

Patent Document 2: Japanese Unexamined Patent Application Publication No. 2000-343906

Patent Document 3: Japanese Unexamined Patent Application Publication No. 2001-80313

### SUMMARY OF THE INVENTION

### Problem to be Solved by the Invention

An object of the present invention is to provide a pneumatic tire by which workability when molding a tire and tire durability performance can be enhanced without increasing tire weight when providing a reinforcing layer formed by aligning a plurality of monofilament steel wires and embedding this plurality of monofilament steel wires in rubber.

Another object of the present invention is to provide a pneumatic radial tire by which rolling resistance can be reduced while maintaining excellent tire durability performance when providing a belt layer formed by aligning a plurality of monofilament steel wires and embedding this plurality of monofilament steel wires in rubber.

### Means to Solve the Problem

A pneumatic tire of a first aspect of the present invention for achieving the objects described above includes a reinforcing layer formed by aligning a plurality of monofilament steel wires and embedding said monofilament steel wires in rubber. In such a pneumatic tire, each of the monofilament steel wires is provided with twisting around an axis thereof, and a wire surface twisting angle with respect to an axial direction of the monofilament steel wires is not less than 1°.

A pneumatic tire of a second aspect of the present invention for achieving the objects described above includes a belt layer disposed on an outer circumferential side of a carcass layer in a tread portion, the belt layer formed by aligning a plurality of monofilament steel wires and embedding said monofilament steel wires in rubber. In such a pneumatic tire, a wire strand diameter d of the monofilament steel wires is from 0.25 mm to 0.40 mm, a tensile strength S (MPa) of the monofilament steel wires has a relationship with the wire strand diameter d such that S>3870-2000×d, each of the monofilament steel wires is provided with twisting around an axis thereof, and a wire surface twisting angle with respect to an axial direction of the monofilament steel wires is not less than 1°.

A pneumatic radial tire of a third aspect of the present invention for achieving the objects described above includes a belt layer disposed on an outer circumferential side of a carcass layer in a tread portion, the belt layer formed by aligning a plurality of monofilament steel wires and embedding said monofilament steel wires in rubber. In such a pneumatic radial tire, each of the monofilament steel wires is provided with twisting around an axis thereof, a wire surface twisting angle with respect to an axial direction of the monofilament steel wires is not less than 1°, a plurality of wire groups including from 2 to 4 of the monofilament steel wires is formed in the belt layer and, the monofilament steel wires are disposed in each of the wire groups so as to be aligned in a planar direction of the belt layer.

### Effect of the Invention

In the first aspect, the monofilament steel wires constituting the reinforcing layer are provided with twisting and the wire surface twisting angle thereof is stipulated. Therefore, fatigue resistance of the monofilament steel wires can be improved, leading to an enhancement in tire durability performance, and straightness of the monofilament steel wires can be improved, leading to enhanced workability when molding a tire. Additionally, cases where monofilament steel wires that have been provided with twisting are used differ from cases where preformed monofilament steel wires are used in that thickness of the reinforcing layer is not increased and, therefore, effects of reducing the weight of the pneumatic tire can be sufficiently ensured.

In the first aspect, in an effort to sufficiently obtain the effects described above, the wire surface twisting angle with respect to an axial direction of the monofilament steel wires is preferably from 1° to 15°. A wire strand diameter of the monofilament steel wires is preferably from 0.20 mm to 0.50 mm. Additionally, a wire density of the monofilament steel wires in the reinforcing layer is preferably from 50 wires/50 mm to 90 wires/50 mm

The reinforcing layer to which the monofilament steel wires described above are applied is not particularly limited, but the monofilament steel wires are preferably applied to a belt layer, a belt cover layer, a carcass layer, or a side reinforcing layer that constitute a pneumatic tire.

In the second aspect, when using the monofilament steel wires having a large tensile strength S as the reinforcing cords of the belt layer, the monofilament steel wires constituting the reinforcing layer are provided with twisting and the wire surface twisting angle thereof is stipulated. Therefore, orientation of metal material in the monofilament steel wires that is caused by wire drawing is mitigated and, as a result, the fatigue resistance of the monofilament steel wires can be improved and the tire durability performance can be enhanced. Additionally, cases where monofilament steel wires that have been provided with twisting are used differ from cases where preformed monofilament steel wires are used in that thickness of the belt layer is not increased and, therefore, effects of reducing the rolling resistance of the pneumatic tire based on the use of the monofilament steel wires can be sufficiently ensured.

In the second aspect, it is preferable that the wire surface twisting angle be widened for the purpose of improving the fatigue resistance of the monofilament steel wires, but if the wire surface twisting angle is excessively wide, productivity of the monofilament steel wires will decline and manufacturing will be difficult. Thus, the wire surface twisting angle with respect to the axial direction of the monofilament steel wires is preferably from 1° to 15°.

Additionally, in order to sufficiently ensure the tire durability performance, a wire density of the monofilament steel wires in the belt layer is preferably from 50 wires/50 mm to 90 wires/50 mm

Furthermore, a belt cover layer is preferably wound on at least an outer circumferential side of an edge portion of the belt layer. As a result, the demerit when using monofilament steel wires, that is, separation being prone to occur between the cords and the rubber due to cord spacing being narrow, can be complemented by the belt cover layer.

In the third aspect, when using the monofilament steel wires as the reinforcing cords of the belt layer, the monofilament steel wires constituting the reinforcing layer are provided with twisting and the wire surface twisting angle thereof is stipulated. Therefore, excessive orientation of metal surface material in the monofilament steel wires that is caused by wire drawing is mitigated and, as a result, the fatigue resistance of the monofilament steel wires can be improved and the tire durability performance can be enhanced. Moreover, a plurality of wire groups formed from 2 to 4 monofilament steel wires is formed in the belt layer and, therefore, belt-edge-separation is not prone to occur. Furthermore, even if belt-edge-separation does occur, such separation can be held to within the corresponding wire group and propagation throughout a wide range on the tire circumference can be suppressed. Therefore, failures caused by belt-edge-separation can be prevented and tire durability performance can be enhanced. Additionally, cases where monofilament steel wires that have been provided with twisting are used and the monofilament steel wires are disposed in each of the wire groups so as to be aligned in the planar direction of the belt layer differ from cases where preformed monofilament steel wires are used in that thickness of the belt layer is not increased and, therefore, coating rubber in the belt layer is reduced based on the use of the monofilament steel wires and, thereby, effects of reducing the rolling resistance of the pneumatic radial tire can be sufficiently ensured.

In the third aspect, it is preferable that the wire surface twisting angle be widened for the purpose of improving the fatigue resistance of the monofilament steel wires, but if the wire surface twisting angle is excessively wide, productivity of the monofilament steel wires will decline and manufacturing will be difficult. Thus, the wire surface twisting angle with respect to the axial direction of the monofilament steel wires is preferably from 1° to 15°.

A wire strand diameter of the monofilament steel wires is preferably from 0.20 mm to 0.40 mm. Thus, breaking of the monofilament steel wires can be prevented and belt-edge-separation can be suppressed.

A width of the wire groups is preferably from 100% to 130% of a product of the wire strand diameter and a number of wire strands of the monofilament steel wires. Additionally, a spacing between the wire groups is preferably from 70% to 250% of the wire strand diameter of the monofilament steel wires. Thus, overall strength of the belt layer can be sufficiently ensured and belt-edge-separation can be suppressed.

A thickness of the wire groups is preferably from 100% to 150% of the wire strand diameter of the monofilament steel wires. As a result, the coating rubber in the belt layer can be reduced and, thus, the rolling resistance of the pneumatic radial tire can be sufficiently reduced.

A wire density of the monofilament steel wires in the belt layer is preferably from 50 wires/50 mm to 125 wires/50 mm. Thus, overall strength of the belt layer can be sufficiently ensured and belt-edge-separation can be suppressed.

Furthermore, a belt cover layer is preferably wound on at least an outer circumferential side of an edge portion of the belt layer. Thereby, belt-edge-separation can be more effectively suppressed.

In the first aspect to the third aspect, the wire surface twisting angle θ is measured as described below. First, a monofilament steel wire is removed from the pneumatic tire. This wire is immersed in an organic solvent so as to cause the rubber attached to the surface of the wire to swell and, thereafter, the rubber is removed. Then, the monofilament steel wire is examined using a light microscope. The wire strand diameter d (mm) of the monofilament steel wires is measured and a value that is ½ a twisting pitch P (mm) from a wire drawing mark formed on the wire surface is measured and multiplied by 2 in order to determine the twisting pitch P. The twisting pitch P is an average value of measurements taken at no less than 10 locations. Then, the wire surface twisting angle θ is calculated by substituting the wire strand diameter d and the twisting pitch P in formula (1) below.

θ=A TAN(π×d/P)×180/π (1)

### BRIEF DESCRIPTION OF THE DRAWINGS

FIG. 1 is a meridian cross-sectional view illustrating half of a pneumatic radial tire according to an embodiment of a first aspect.

FIG. 2 is a meridian cross-sectional view illustrating half of a pneumatic radial tire according to an embodiment of a second aspect.

FIG. 3 is a cross-sectional view illustrating an enlarged portion of a belt layer in a pneumatic radial tire according to an embodiment of a third aspect.

FIG. 4 is a side view illustrating monofilament steel wires used in the first aspect to the third aspect.

FIG. 5 is a side view illustrating an enlarged portion of FIG. 4.

### BEST MODE FOR CARRYING OUT THE INVENTION

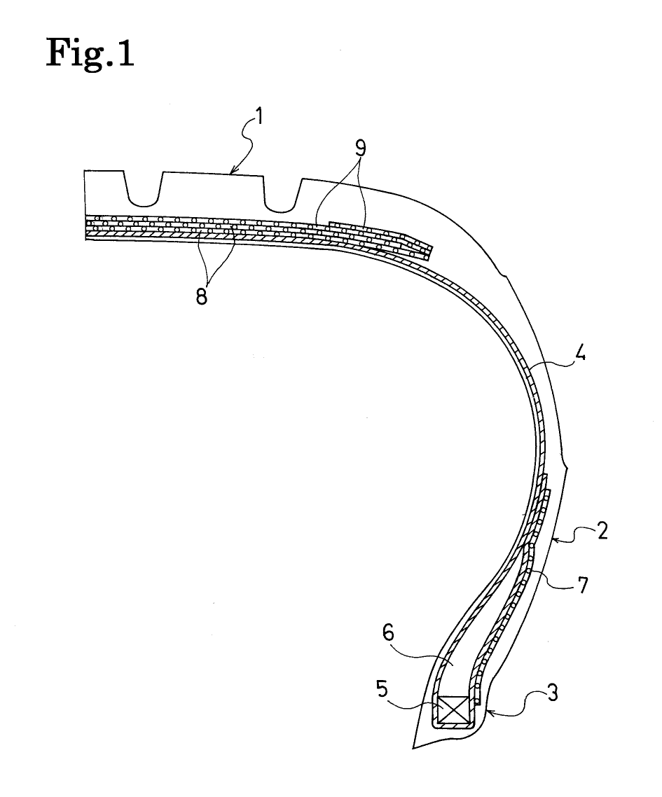

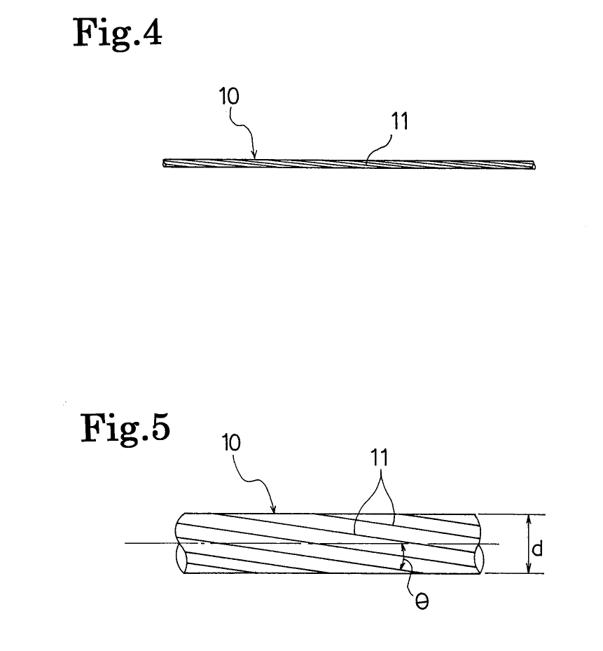

Detailed descriptions will be given below of a configuration of the present invention with reference to the accompanying drawings. FIG. 1 illustrates a pneumatic radial tire according to an embodiment of a first aspect. FIGS. 4 and 5 each illustrate monofilament steel wires used in the pneumatic radial tire.

In FIG. 1, 1 is a tread portion; 2 is a side wall portion; and 3 is a bead portion. A carcass layer 4 is mounted between the left-right pair of bead portions 3,3. The carcass layer 4 includes a plurality of reinforcing cords extending in a tire radial direction, and is folded back around a bead core 5 disposed in each of the bead portions 3 from a tire inner side to a tire outer side.

Additionally, a bead filler 6 is disposed on a periphery of the bead core 5, and the bead filler 6 is enveloped by a main body part and the folded over part of the carcass layer 4. Additionally, a side reinforcing layer 7 including a plurality of aligned reinforcing cords is embedded throughout an entire circumference of the tire from the bead portion 3 to the side wall portion 2. In the side reinforcing layer 7, an inclination angle of the reinforcing cords with respect to a tire circumferential direction is set in a range from, for example, 10° to 60°. The inclination angle of the reinforcing cords of the side reinforcing layer 7 can be appropriately set depending on the needed steering stability. Steering stability can be enhanced by enlarging the inclination angle.

On the other hand, a plurality of layers of a belt layer 8 is embedded on an outer circumferential side of the carcass layer 4 in the tread portion 1. These belt layers 8 include a plurality of reinforcing cords that incline with respect to the tire circumferential direction, and the reinforcing cords are disposed between the layers so as to intersect each other. In the belt layers 8, an inclination angle of the reinforcing cords with respect to the tire circumferential direction is set in a range from, for example, 10° to 40°.

For the purpose of enhancing high-speed durability, at least one layer of a belt cover layer 9 formed by arranging reinforcing cords at an angle of, for example, not more than 5° with respect to the tire circumferential direction, is disposed on an outer circumferential side of the belt layers 8. The belt cover layer 9 preferably has a jointless structure and includes a strip material continuously wrapped in the tire circumferential direction. The strip material preferably includes at least one reinforcing cord that has been aligned and coated with rubber.

In the pneumatic radial tire described above, monofilament steel wires 10 (see FIGS. 4 and 5) that are provided with twisting around an axis thereof are used as reinforcing cords constituting at least one reinforcing layer selected from the carcass 4, the side reinforcing layer 7, the belt layer 8, and the belt cover layer 9 (preferably the belt layer 8). In FIGS. 4 and 5, a wire drawing mark 11 caused by wire drawing is formed on a surface of the monofilament steel wires 10, and a wire surface twisting angle θ with respect to the axial direction of the monofilament steel wires 10 that is determined based on the wire drawing mark 11 is not less than 1°, more preferably in a range from 1° to 15°, and even more preferably in a range from 1° to 6°.

In the pneumatic radial tire including the reinforcing layer formed by aligning the plurality of monofilament steel wires 10 and embedding the monofilament steel wires 10 in rubber as described above, each of the monofilament steel wires 10 is provided with the twisting around the axis thereof, and the wire surface twisting angle θ with respect to the axial direction of the monofilament steel wires 10 is stipulated. Therefore, fatigue resistance of the monofilament steel wires 10 can be improved, leading to an enhancement in tire durability performance, and straightness of the monofilament steel wires 10 can be improved, leading to enhanced workability when molding a tire. Additionally, the thickness of the reinforcing layer does not increase even with the twisting being provided to the monofilament steel wires 10 and, therefore, effects of reducing the weight of the pneumatic radial tire can be sufficiently ensured.

In this case, if the wire surface twisting angle θ is less than 1°, effects of improving the straightness and the fatigue resistance of the monofilament steel wires 10 will be insufficient. On the other hand, if the wire surface twisting angle θ exceeds 15°, productivity of the monofilament steel wires 10 will decline and manufacturing will be difficult. Additionally, while straightness is improved when the wire surface twisting angle θ is excessively large, tire durability performance may decline due to a decrease in strength of the monofilament steel wires 10 caused by excessive twisting.

In the pneumatic radial tire described above, a wire strand diameter d of the monofilament steel wires 10 is preferably from 0.20 mm to 0.50 mm. If the wire strand diameter d is less than 0.20 mm, it will be necessary to increase the wire count per unit width of the monofilament steel wires 10 in order to ensure overall strength of the reinforcing layer. As a result, workability when calendering reinforcing material corresponding to the reinforcing layer will be negatively affected. On the other hand, if the wire strand diameter d exceeds 0.50 mm, the thickness of the reinforcing layer will increase and the effects of reducing the weight of the pneumatic radial tire will decline.

Additionally, a wire density of the monofilament steel wires 10 in the reinforcing layer is preferably from 50 wires/50 mm to 90 wires/50 mm. If the wire density is less than 50 wires/50 mm, it will be difficult to ensure the overall strength of the reinforcing layer. On the other hand, if the wire density exceeds 90 wires/50 mm, workability when calendering the reinforcing material corresponding to the reinforcing layer will be negatively affected.

In the pneumatic radial tire described above, reinforcing cords generally used in the tire industry can be used as reinforcing cords in portions (e.g. the carcass layer 4, the side reinforcing layer 7, the belt layer 8, and the belt cover layer 9) where the monofilament steel wires 10 are not used. Examples of such reinforcing cords include steel cords formed by twisting a plurality of filaments together and organic fiber cords exemplified by nylon and polyester cords.

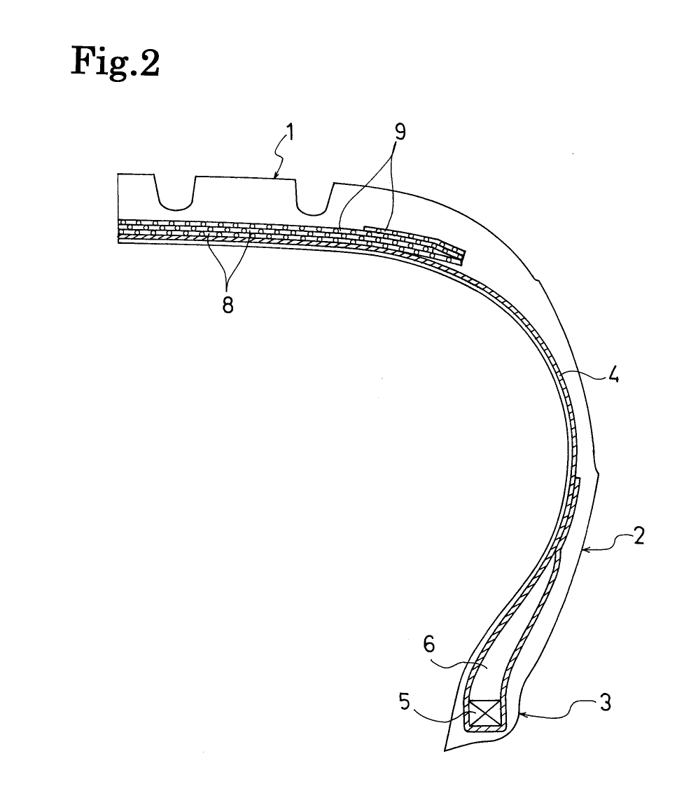

FIG. 2 illustrates a pneumatic radial tire according to an embodiment of a second aspect. In FIG. 2, 1 is a tread portion, 2 is a side wall portion, and 3 is a bead portion. A carcass layer 4 is mounted between the left-right pair of bead portions 3,3. The carcass layer 4 includes a plurality of reinforcing cords extending in a tire radial direction, and is folded back around a bead core 5 disposed in each of the bead portions 3 from a tire inner side to a tire outer side. Generally speaking, organic fiber cords are used as the reinforcing cords of each carcass layer 4. However, steel cords may be instead used as the reinforcing cords. Additionally, a bead filler 6 is disposed on a periphery of the bead core 5, and the bead filler 6 is enveloped by a main body part and the folded over part of the carcass layer 4.

On the other hand, a plurality of layers of a belt layer 8 is embedded on an outer circumferential side of the carcass layer 4 in the tread portion 1. These belt layers 8 include a plurality of reinforcing cords that incline with respect to a tire circumferential direction, and the reinforcing cords are disposed between the layers so as to intersect each other. In the belt layers 8, an inclination angle of the reinforcing cords with respect to the tire circumferential direction is set in a range from, for example, 10° to 40°.

For the purpose of enhancing high-speed durability, at least one layer of a belt cover layer 9 formed by arranging reinforcing cords at an angle of, for example, not more than 5° with respect to the tire circumferential direction, is disposed on an outer circumferential side of the belt layers 8. A belt cover layer 9 preferably has a jointless structure and includes a strip material continuously wrapped in the tire circumferential direction. The strip material preferably includes at least one reinforcing cord that has been aligned and coated with rubber. Additionally, as illustrated in the drawings, the belt cover layer 9 may be disposed so as to cover all regions of the belt layer 8 in a width direction or, alternately, the belt cover layer 9 may be disposed so as to cover only an edge portion of the belt layer 8 on an outer side in the width direction. Preferable examples of cords used as the reinforcing cords of the belt cover layer 9 include cords constituted from a single organic fiber such as nylon, PET, aramid, or the like, or a combination thereof.

In the pneumatic radial tire described above, the monofilament steel wires 10 (see FIGS. 4 and 5) that are provided with twisting around the axis thereof are used as reinforcing cords constituting the belt layer 8. In FIGS. 4 and 5, the wire drawing mark 11 caused by wire drawing is formed on a surface of the monofilament steel wires 10, and the wire surface twisting angle θ with respect to the axial direction of the monofilament steel wires 10 that is determined based on the wire drawing mark 11 is not less than 1° and is more preferably in a range from 1° to 15°.

In the pneumatic radial tire including the belt layer 8 formed by aligning the plurality of monofilament steel wires 10 and embedding the monofilament steel wires 10 in rubber as described above, each of the monofilament steel wires 10 is provided with the twisting around the axis thereof, and the wire surface twisting angle θ with respect to the axial direction of the monofilament steel wires 10 is stipulated. Therefore, orientation of the metal material in the monofilament steel wires 10 that is caused by the wire drawing is mitigated and, as a result, the fatigue resistance of the monofilament steel wires 10 can be improved and the tire durability performance can be enhanced. Additionally, the thickness of the belt layer 8 does not increase even with the twisting being provided to the monofilament steel wires 10 and, therefore, the coating rubber of the belt layer 8 is reduced based on the use of the monofilament steel wires 10 and, thus, the rolling resistance of the pneumatic radial tire can be reduced.

In this case, if the wire surface twisting angle θ is less than 1°, the effects of improving the fatigue resistance of the monofilament steel wires 10 will be insufficient. Additionally, if the wire surface twisting angle θ exceeds 15°, productivity of the monofilament steel wires 10 will decline and manufacturing will be difficult.

In the pneumatic radial tire described above, the wire strand diameter d of the monofilament steel wires 10 is from 0.25 mm to 0.40 mm. If the wire strand diameter d is less than 0.25 mm, spacing between the monofilament steel wires 10 will be narrowed in order to ensure the overall strength of the belt layer 8 and, as a result, the tire durability performance will be negatively affected. On the other hand, if the wire strand diameter d exceeds 0.40 mm, the fatigue resistance of the monofilament steel wires 10 will decline and, thus, the tire durability performance will be negatively affected.

Additionally, a tensile strength S (MPa) of the monofilament steel wires 10 has a relationship with the wire strand diameter d such that S>3870-2000×d. That is, the monofilament steel wires 10 are imparted with high tensile force properties. In this case, if the tensile strength S is too low, it will not be possible to reduce the rolling resistance while maintaining the tire durability performance. An upper limit of the tensile strength S is not particularly limited and is, for example, 4,500 MPa.

Additionally, the wire density of the monofilament steel wires 10 in the reinforcing layer is preferably from 50 wires/50 mm to 90 wires/50 mm. If the wire density is less than 50 wires/50 mm, it will be difficult to ensure the overall strength of the belt layer 8. On the other hand, if the wire density exceeds 90 wires/50 mm, spacing between the monofilament steel wires 10 will be narrowed and, as a result, the tire durability performance will be negatively affected.

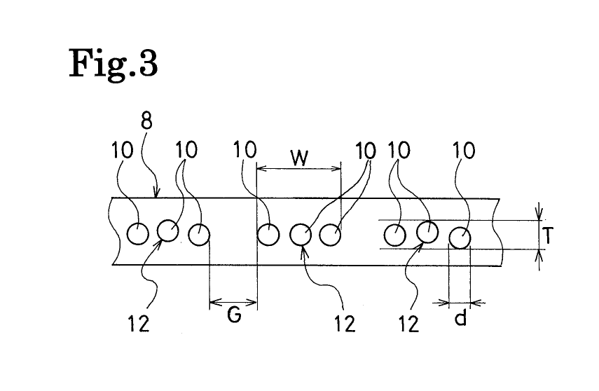

Next, a pneumatic radial tire according to an embodiment of a third aspect will be described. The pneumatic radial tire of the third aspect differs from the pneumatic radial tire according to the embodiment of the second aspect on only the point of the structure of the belt layer. Therefore, description of components other than the belt layer shall be omitted. FIG. 3 is a drawing illustrating a portion of the belt layer in the pneumatic radial tire according to the embodiment of the third aspect.

In this pneumatic radial tire, the monofilament steel wires 10 (see FIGS. 4 and 5) that are provided with twisting around the axis thereof are used as reinforcing cords constituting the belt layer 8. In FIGS. 4 and 5, the wire drawing mark 11 caused by the wire drawing is formed on the surface of the monofilament steel wires 10, and the wire surface twisting angle θ with respect to the axial direction of the monofilament steel wires 10 that is calculated from a twisting pitch P (mm) determined based on the wire drawing mark 11 and the wire strand diameter d (mm) of the monofilament steel wires 10 is not less than 1°, and is more preferably in a range from 1° to 15°.

As illustrated in FIG. 3, in the belt layer 8, one wire group 12 is formed by disposing from 2 to 4 of the monofilament steel wires 10 close to each other. A plurality of the wire groups 12 formed in such a manner is disposed at a predetermined spacing in a direction orthogonal to a longitudinal direction of the monofilament steel wires 10. Note that in FIG. 3, three of the monofilament steel wires 10 are formed into one of the wire groups 12. In each of the wire groups 12, the monofilament steel wires 10 are disposed so as to be aligned in a planar direction of the belt layer 8.

In the pneumatic radial tire including the belt layer 8 formed by aligning the plurality of monofilament steel wires 10 and embedding the monofilament steel wires 10 in rubber as described above, each of the monofilament steel wires 10 is provided with the twisting around the axis thereof, and the wire surface twisting angle θ with respect to the axial direction of the monofilament steel wires 10 is stipulated. Therefore, excessive orientation of the metal surface material in the monofilament steel wires 10 that is caused by the wire drawing is mitigated and, as a result, the fatigue resistance of the monofilament steel wires 10 can be improved and the tire durability performance can be enhanced.

In this case, if the wire surface twisting angle θ is less than 1°, the effects of improving the fatigue resistance of the monofilament steel wires 10 will be insufficient. On the other hand, if the wire surface twisting angle θ exceeds 15°, productivity of the monofilament steel wires 10 will decline and manufacturing will be difficult.

Additionally, in the pneumatic radial tire described above, the plurality of wire groups 12 formed from 2 to 4 of the monofilament steel wires 10 is formed in the belt layer 8 and, therefore, belt-edge-separation is not prone to occur. Furthermore, even if belt-edge-separation does occur, such separation can be held to within the corresponding wire group 12 and propagation throughout a wide range on the tire circumference can be suppressed. Therefore, failures caused by belt-edge-separation can be prevented and tire durability performance can be enhanced. Note that if the number of the monofilament steel wires 10 constituting the wire groups 12 is five or greater, belt-edge-separation will easily occur throughout a relatively large range in the wire groups 12.

In this case, it is important that each of the wire groups 12 has integrity and that appropriate spacing between pairs of adjacent wire groups 12 is provided. Therefore, in FIG. 3, a width W of the wire groups 12 is preferably from 100% to 130% and more preferably from 103% to 120% of a product of the wire strand diameter d and a number of wire strands n of the monofilament steel wires 10 (d×n). If the width W of the wire groups 12 is less than 100% of the product of the wire strand diameter d and the number of wire strands n of the monofilament steel wires 10 (d×n), belt-edge-separation will easily occur. On the other hand, if the width W of the wire groups 12 exceeds 130% of the product of the wire strand diameter d and the number of wire strands n of the monofilament steel wires 10 (d×n), overall strength of the belt layer 8 will be difficult to ensure. Additionally, a mutual spacing G between adjacent pairs of the wire groups 12 is preferably from 70% to 250% of the wire strand diameter d of the monofilament steel wires 10. If the mutual spacing G between the wire groups 12 is less than 70% of the wire strand diameter d, belt-edge-separation will easily propagate throughout a wide range. On the other hand, if the mutual spacing G exceeds 250% of the wire strand diameter d, overall strength of the belt layer 8 will be difficult to ensure.

Furthermore, in the pneumatic radial tire described above, the monofilament steel wires 10 that have been provided with twisting are used and the monofilament steel wires 10 are disposed in each of the wire groups 12 so as to be aligned in the planar direction of the belt layer 8. Therefore, coating rubber in the belt layer 8 is reduced based on the use of the monofilament steel wires 10 and, thereby, effects of reducing the rolling resistance of the pneumatic radial tire can be sufficiently ensured.

In this case, it is important that each of the wire groups 12 have flatness. Therefore, in FIG. 3, a thickness T of the wire groups 12, measured along a thickness direction of the belt layer 8, is preferably from 100% to 150% of the wire strand diameter d of the monofilament steel wires 10. If the thickness T of the wire groups 12 exceeds 150% of the wire strand diameter d, the thickness of the belt layer 8 will increase and, as a result, the effects of reducing the rolling resistance will be insufficient.

In the pneumatic radial tire described above, the wire strand diameter d of the monofilament steel wires 10 is preferably from 0.20 mm to 0.40 mm. If this wire strand diameter d is less than 0.20 mm, belt-edge-separation will easily occur. On the other hand, if this wire strand diameter d exceeds 0.40 mm, the monofilament steel wires 10 will easily break.

Additionally, the wire density of the monofilament steel wires 10 in the belt layer 8 is preferably from 50 wires/50 mm to 125 wires/50 mm. If the wire density is less than 50 wires/50 mm, it will be difficult to ensure the overall strength of the belt layer 8. On the other hand, if the wire density exceeds 125 wires/50 mm, spacing between the monofilament steel wires 10 will be narrowed and, as a result, the tire durability performance will be negatively affected.

Detailed descriptions of preferred embodiments of the present invention have been given above, but it shall be understood that various modifications, substitutions, and replacements can be carried out provided that such do not stray from the spirit and scope of the present invention stipulated in the attached claims.

### EXAMPLES

### First Aspect

Tires of Conventional Examples 1 and 2, Comparative Example 1, and Working Examples 1 to 4 were fabricated having a common tire size of 195/65R15. Each tire was a pneumatic radial tire including a belt layer formed from a plurality of monofilament steel wires that were aligned and embedded in rubber. The wire surface twisting angle θ, the wire strand diameter d, the wire density, and the presence/absence of preforming of the monofilament steel wires were configured as shown in Table 1.

Note that in Conventional Example 2, monofilament steel wires having a wire strand diameter of 0.4 mm were subjected to spiral preforming. An outer diameter of the spiral was 0.44 mm and a pitch of the spiral was 4.0 mm

These test tires were evaluated for calendering workability, cutting workability, tire weight, and tire durability performance according to the following evaluation methods. The results thereof are shown in Table 1.

### Calendering Workability:

Workability when calendering a belt member that becomes the belt layer, formed by aligning a plurality of monofilament steel wires and embedding the monofilament steel wires in rubber, was evaluated. When workability was superior, a score of “A” was given; when workability was excellent, a score of “B” was given;

when workability was acceptable, a score of “C” was given; and when workability was difficult, a score of “D” was given.

### Cutting Workability:

Workability when cutting a belt member that becomes the belt layer to predetermined dimensions, formed by aligning a plurality of monofilament steel wires and embedding the monofilament steel wires in rubber, was evaluated. When workability was superior, a score of “A” was given; when workability was excellent, a score of “B” was given; when workability was acceptable, a score of “C” was given; and when workability was difficult, a score of “D” was given.

### Tire Weight:

Weight of the belt member that becomes the belt layer of each of the test tires was measured. Evaluation results were expressed as index values, Conventional Example 1 being assigned an index value of 100. Larger index values indicate greater tire weight.

### Tire Durability Performance:

Each of the test tires was assembled on a rim and inflated to an air pressure of 170 kPa. The test tires were run on a drum having a diameter of 1,707 mm at a speed of 25 km/hr while rectangular wave fluctuating the load (variation range: 3.2 kN±2.1 kN) and the slip angle (variation range: 0°±4°) at a frequency of 0.067 Hz. Thus, running distance at which the test tires failed was measured. Evaluation results were expressed as index values, Conventional Example 1 being assigned an index value of 100. A larger index value indicates superior tire durability performance

TABLE 1

| | | | | Working | Working | Working | Working |
|---|---|---|---|---|---|---|---|
| | Conventional | Conventional | Comparative | Example | Example | Example | Example |
| | Example 1 | Example 2 | Example 1 | 1 | 2 | 3 | 4 |
| Wire surface | 0 | 0 | 0.5 | 1 | 4 | 6 | 12 |
| twisting angle θ | | | | | | | |
| (°) | | | | | | | |
| Wire strand | 0.4 | 0.4 | 0.4 | 0.4 | 0.4 | 0.4 | 0.4 |
| diameter d (mm) | | | | | | | |
| Cord density | 60 | 60 | 60 | 60 | 60 | 60 | 60 |
| (cord/50 mm) | | | | | | | |
| Presence/absence | Absent | Present | Absent | Absent | Absent | Absent | Absent |
| of performing | | | | | | | |
| Calendering | D | B | C | B | A | A | A |
| workability | | | | | | | |
| Cutting | D | B | C | B | A | A | A |
| workability | | | | | | | |
| Tire weight | 100 | 120 | 100 | 100 | 100 | 100 | 100 |
| Tire durability | 100 | 100 | 105 | 115 | 125 | 125 | 110 |
| performance | | | | | | | |

As is evident from Table 1, compared to Conventional Example 1, with the tires of Working Examples 1 to 4, the tire durability performance, the calendering workability, and the cutting workability were enhanced while maintaining equivalent tire weight. In contrast, with the tire of Conventional Example 2, the monofilament steel wires were preformed with a spiral shape and, therefore, while effects of improving the calendering workability and the cutting workability were displayed, the tire weight increased.

On the other hand, with the tire of Comparative Example 1, the wire surface twisting angle θ was too small and, therefore, the effects of improving the tire durability performance, the calendering workability, and the cutting workability were insufficient.

Next, tires of Conventional Examples 3 and 4 that had the same structure as the tire of Conventional Example 1 except that the wire strand diameter d of the monofilament steel wires was varied, and tires of Working Examples 5 and 6 that had the same structure as the tire of Working Example 1 except that the wire strand diameter d of the monofilament steel wires was varied were fabricated.

These test tires were evaluated for calendering workability, cutting workability, tire weight, and tire durability performance according to the evaluation methods described above. The results thereof are shown in Table 2. Note that Conventional Example 1 was used as the evaluation standard for the tire weight and the tire durability performance

TABLE 2

| | Conventional | Working | Conventional | Working |
|---|---|---|---|---|
| | Example 3 | Example 5 | Example 4 | Example 6 |
| Wire surface | 0 | 4 | 0 | 4 |
| twisting angle θ (°) | | | | |
| Wire strand | 0.2 | 0.2 | 0.5 | 0.5 |
| diameter d (mm) | | | | |
| Cord density | 60 | 60 | 60 | 60 |
| (cord/50 mm) | | | | |
| Presence/absence | Absent | Absent | Absent | Absent |
| of performing | | | | |
| Calendering | D | B | D | A |
| workability | | | | |
| Cutting workability | D | B | D | A |
| Tire weight | 90 | 90 | 110 | 110 |
| Tire durability | 90 | 110 | 90 | 110 |
| performance | | | | |

As is evident from Table 2, compared to Conventional Example 3, with the tire of Working Example 5, the tire durability performance, the calendering workability, and the cutting workability were enhanced while maintaining equivalent tire weight. Likewise, compared to Conventional Example 4, with the tire of Working Example 6, the tire durability performance, the calendering workability, and the cutting workability were enhanced while maintaining equivalent tire weight.

### Second Aspect

Tires of Conventional Example 11, Working Examples 11 to 14, and Comparative Examples 11 to 14 were fabricated having a common tire size of 195/65R15. Each tire was a pneumatic radial tire including a belt layer formed from a plurality of reinforcing cords that were aligned and embedded in rubber. The structure, the wire strand diameter d, the strength, the tensile strength, and the wire surface twisting angle θ of the reinforcing cords of the belt layer were configured as shown in Table 3.

In the tire of Conventional Example 11, steel cords having a 1×3 structure formed by twisting three filaments where the wire strand diameter d was 0.28 mm together were used as the reinforcing cords of the belt layer. On the other hand, in the tires of Working Examples 11 to 14 and Comparative Examples 11 to 14, monofilament steel wires having a wire strand diameter d from 0.23 mm to 0.42 mm were used as the reinforcing cords of the belt layer. In Conventional Example 11, Working Examples 11 to 14, and Comparative Examples 11 to 14, the product of the strength (N) and the cord density (cords/50 mm) of the reinforcing cords in the belt layer was constant.

These test tires were evaluated for tire durability performance and rolling resistance according to the evaluation methods described below. Results thereof are shown in Table 3.

### Tire Durability Performance:

Each of the test tires was assembled on a rim and the tires were filled with oxygen. The internal pressure of the oxygen was adjusted to 350 kPa. The tires were then subjected to dry-heat degradation at a temperature of 80° C. for five days. After the dry-heat degradation, the oxygen in the tire was replaced with air and the air pressure was adjusted to 200 kPa. Then, the test tires were subjected to a running test under the following conditions: speed=120 km/hr and applied load=5 kN. The running test was started and every 24 hours the speed was increased 10 km/hr. Thus, running distance at which the test tires failed was measured. Evaluation results were expressed as index values, Conventional Example 11 being assigned an index value of 100. A larger index value indicates superior tire durability performance.

### Rolling Resistance:

Each of the test tires were assembled on a rim and inflated to an air pressure of 230 kPa. Rolling resistance of the test tires was measured under the following conditions: speed=80 km/hr and applied load=6.15 kN. Evaluation results were expressed as index values, Conventional Example 11 being assigned an index value of 100. Smaller index values indicate less rolling resistance.

TABLE 3

| | | Conven- | | | | | Compar- | Compar- | Compar- | Compar- |
|---|---|---|---|---|---|---|---|---|---|---|
| | | tional | Working | Working | Working | Working | ative | ative | ative | ative |
| | | Example | Example | Example | Example | Example | Example | Example | Example | Example |
| | | 11 | 11 | 12 | 13 | 14 | 11 | 12 | 13 | 14 |
| Reinforcing | Structure | 1 × 3 | Mono- | Mono- | Mono- | Mono- | Mono- | Mono- | Mono- | Mono- |
| cords of the | | | filament | filament | filament | filament | filament | filament | filament | filament |
| belt layer | Wire strand | 0.28 | 0.32 | 0.32 | 0.32 | 0.32 | 0.23 | 0.42 | 0.32 | 0.32 |
| | diameter d | | | | | | | | | |
| | (mm) | | | | | | | | | |
| | Strength (N) | 588 | 290 | 290 | 290 | 290 | 158 | 471 | 253 | 290 |
| | Tensile | 3183 | 3600 | 3600 | 3600 | 3600 | 3800 | 3400 | 3150 | 3600 |
| | strength | | | | | | | | | |
| | (MPa) | | | | | | | | | |
| | Wire surface | 0 | 1 | 3 | 15 | 20 | 2 | 5 | 3 | 0 |
| | twisting | | | | | | | | | |
| | angle θ (°) | | | | | | | | | |

| | | | | | | | | | |
|---|---|---|---|---|---|---|---|---|---|
| Presence/absence | Absent | Absent | Absent | Absent | Absent | Absent | Absent | Absent | Absent |
| of belt cover layer | | | | | | | | | |
| Tire durability | 100 | 100 | 100 | 100 | 101 | 90 | 85 | 98 | 95 |
| performance | | | | | | | | | |
| Rolling resistance | 100 | 95 | 95 | 95 | 95 | 93 | 98 | 95 | 95 |

It is evident from Table 3 that, compared to the tire of Comparative Example 11, the tires of Working Examples 11 to 14 were able to reduce rolling resistance while maintaining excellent tire durability performance. In contrast, with the tires of Comparative Examples 11 to 14, while an effect of reducing the rolling resistance was displayed, tire durability performance decreased. Particularly, in Comparative Examples 11 and 13, separation between the monofilament steel wires and the coating rubber of the belt layer occurred, and in Comparative Examples 12 and 14, breakage of the monofilament steel wires of the belt layer occurred.

Next, a tire of Conventional Example 12 that had the same structure as the tire of Conventional Example 11 except that a belt cover layer was added on the outer circumferential side of the belt layer, and tires of Working Examples 15 to 18 that had the same structures as the tires of Working Examples 11 to 14, respectively, except that a belt cover layer was added on the outer circumferential side of the belt layer and the wire strand diameter d of the monofilament steel wires was varied were fabricated. In Conventional Example 12 and Working Examples 15 to 18, the product of the strength (N) and the cord density (cords/50 mm) of the reinforcing cords in the belt layer was constant.

These test tires were evaluated for tire durability performance and rolling resistance according to the evaluation methods described above. Results thereof are shown in Table 4. Note that Conventional Example 12 was used as the evaluation standard for the tire durability performance and the rolling resistance.

TABLE 4

| | | Conventional | Working | Working |
|---|---|---|---|---|
| | | Example 12 | Example 15 | Example 16 |
| Rein- | Structure | 1 × 3 | Monofil- | Monofil- |
| forcing | | | ament | ament |
| cords of | Wire strand | 0.28 | 0.28 | 0.28 |
| the belt | diameter d (mm) | | | |
| layer | Strength (N) | 588 | 206 | 206 |
| | Tensile | 3183 | 3350 | 3350 |
| | strength (MPa) | | | |
| | Wire surface | 0 | 1 | 3 |
| | twisting angle | | | |
| | θ (°) | | | |

| | | | |
|---|---|---|---|
| Presence/absence of belt cover | Present | Present | Present |
| layer | | | |
| Tire durability performance | 100 | 100 | 100 |
| Rolling resistance | 100 | 93 | 93 |

| | | Working | Working |
|---|---|---|---|
| | | Example 17 | Example 18 |
| Rein- | Structure | Monofil- | Monofil- |
| forcing | | ament | ament |
| cords of | Wire strand | 0.28 | 0.28 |
| the belt | diameter d (mm) | | |
| layer | Strength (N) | 206 | 206 |
| | Tensile | 3350 | 3350 |
| | strength (MPa) | | |
| | Wire surface | 15 | 20 |
| | twisting angle θ | | |
| | (°) | | |

| | | |
|---|---|---|
| Presence/absence of belt cover | Present | Present |
| layer | | |
| Tire durability performance | 100 | 101 |
| Rolling resistance | 93 | 93 |

It is evident from Table 4 that, compared to the tire of Comparative Example 12, the tires of Working Examples 15 to 18 were able to reduce rolling resistance while maintaining excellent tire durability performance. Particularly, in Working Examples 15 to 18, rolling resistance was further reduced by configuring the wire strand diameter d of the monofilament steel wires to be less than that of the tires of Working Examples 11 to 14, and, because the belt cover layer pressed down on the monofilament steel wires of the belt layer, it was possible to maintain excellent tire durability performance

### Third Aspect

Tires of Conventional Example 21, Working Examples 21 to 24, and Comparative Examples 21 to 24 were fabricated having a common tire size of 195/65R15. Each tire was a pneumatic radial tire including a belt layer formed from a plurality reinforcing cords that were aligned and embedded in rubber. The structure, the wire strand diameter d, and the wire surface twisting angle θ of the reinforcing cords of the belt layer; and the number of wire strands n of the monofilament steel wires constituting the wire groups, the width (W/(d×n)×100%) of the wire groups, the spacing (G/d×100%) between each of the wire groups, and the thickness (T/d×100%) of the wire groups were configured as shown in Table 5.

In the tire of Conventional Example 21, steel cords having a 1×3 structure, formed by twisting three filaments where the wire strand diameter d was 0.30 mm together, were used as the reinforcing cords of the belt layer. These steel cords were disposed at equal intervals. On the other hand, in the tires of Working Examples 21 to 24 and Comparative Examples 21 to 24, monofilament steel wires having a wire strand diameter d of 0.30 mm were used as the reinforcing cords of the belt layer. In Conventional Example 21, Working Examples 21 to 24, and Comparative Examples 21 to 24, the product of the weight (g/m) and the cord density (cords/50 mm) of the reinforcing cords in the belt layer was constant.

These test tires were evaluated for tire durability performance and rolling resistance according to the evaluation methods described below. Results thereof are shown in Table 5.

### Tire Durability Performance:

Each of the test tires was assembled on a rim and the tires were filled with oxygen. The internal pressure of the oxygen was adjusted to 350 kPa. The tires were then subjected to dry-heat degradation at a temperature of 80° C. for five days. After the dry-heat degradation, the oxygen in the tire was replaced with air and the air pressure was adjusted to 200 kPa. Then, the test tires were subjected to a running test under the following conditions: speed=120 km/hr and applied load=5 kN. The running test was started and every 24 hours the speed was increased 10 km/hr. Thus, running distance at which the test tires failed was measured. Evaluation results were expressed as index values, Conventional Example 21 being assigned an index value of 100. A larger index value indicates superior tire durability performance.

### Rolling Resistance:

Each of the test tires were assembled on a rim and inflated to an air pressure of 230 kPa. Rolling resistance of the test tires was measured under the following conditions: speed=80 km/hr and applied load=6.15 kN. Evaluation results were expressed as index values, Conventional Example 21 being assigned an index value of 100. Smaller index values indicate less rolling resistance.

TABLE 5

| | | Conven- | | | | | Compar- | Compar- | Compar- | Compar- |
|---|---|---|---|---|---|---|---|---|---|---|
| | | tional | Working | Working | Working | Working | ative | ative | ative | ative |
| | | Example | Example | Example | Example | Example | Example | Example | Example | Example |
| | | 21 | 21 | 22 | 23 | 24 | 21 | 22 | 23 | 24 |
| Reinforcing | Structure | 1 × 3 | Mono- | Mono- | Mono- | Mono- | Mono- | Mono- | Mono- | Mono- |
| cords of the | | | filament | filament | filament | filament | filament | filament | filament | filament |
| belt layer | Wire strand | 0.30 | 0.30 | 0.30 | 0.30 | 0.30 | 0.30 | 0.30 | 0.30 | 0.30 |
| | diameter d | | | | | | | | | |
| | (mm) | | | | | | | | | |
| | Wire surface | — | 3 | 3 | 15 | 15 | 0 | 3 | 3 | 3 |
| | twisting | | | | | | | | | |
| | angle θ (°) | | | | | | | | | |
| | Number of | (1) | 2 | 4 | 2 | 4 | 2 | 1 | 5 | 2 |
| | wire strands n | | | | | | | | | |
| | of the wire | | | | | | | | | |
| | groups | | | | | | | | | |
| | W/(d × n) × 100% | 99 | 107 | 107 | 107 | 107 | 107 | 100 | 107 | 107 |
| | G/d × 100% | 210 | 113 | 227 | 113 | 227 | 113 | 63 | 283 | 113 |
| | T/d × 100% | 200 | 133 | 133 | 133 | 133 | 133 | 100 | 133 | 213 |

| | | | | | | | | | |
|---|---|---|---|---|---|---|---|---|---|
| Presence/absence | Absent | Absent | Absent | Absent | Absent | Absent | Absent | Absent | Absent |
| of belt cover layer | | | | | | | | | |
| Tire durability | 100 | 100 | 100 | 101 | 101 | 90 | 85 | 98 | 100 |
| performance | | | | | | | | | |
| Rolling resistance | 100 | 95 | 95 | 95 | 95 | 95 | 95 | 95 | 100 |

It is evident from Table 5 that, compared to the tire of Comparative Example 21, the tires of Working Examples 21 to 24 were able to reduce rolling resistance while maintaining excellent tire durability performance. In contrast, with the tires of Comparative Examples 21 to 23, while an effect of reducing the rolling resistance was displayed, tire durability performance decreased. Particularly, in Comparative Example 21, breakage of the monofilament steel wires of the belt layer occurred; and in Comparative Examples 22 and 23, separation between the monofilament steel wires and the coating rubber of the belt layer occurred. Additionally, with the tire of Comparative Example 24, no merit was realized because the wire groups were not flat.

Next, a tire of Conventional Example 22 that had the same structure as the tire of Conventional Example 21 except that a belt cover layer was added on the outer circumferential side of the belt layer, and tires of Working Examples 25 to 28 that had the same structures as the tires of Working Examples 21 to 24, respectively, except that a belt cover layer was added on the outer circumferential side of the belt layer and the wire strand diameter d of the monofilament steel wires was varied were fabricated. In Conventional Example 22 and Working Examples 25 to 28, the product of the weight (g/m) and the cord density (cords/50 mm) of the reinforcing cords in the belt layer was constant.

These test tires were evaluated for tire durability performance and rolling resistance according to the evaluation methods described above. Results thereof are shown in Table 6. Note that Conventional Example 22 was used as the evaluation standard for the tire durability performance and the rolling resistance.

TABLE 6

| | | Conventional | Working | Working | Working | Working |
|---|---|---|---|---|---|---|
| | | Example 22 | Example 25 | Example 26 | Example 27 | Example 28 |
| Reinforcing | Structure | 1 × 3 | Mono- | Mono- | Mono- | Mono- |
| cords of the | | | filament | filament | filament | filament |
| belt layer | Wire strand | 0.30 | 0.30 | 0.30 | 0.30 | 0.30 |
| | diameter d | | | | | |
| | (mm) | | | | | |
| | Wire surface | — | 3 | 3 | 15 | 15 |
| | twisting | | | | | |
| | angle θ (°) | | | | | |
| | Number of | (1) | 2 | 4 | 2 | 4 |
| | wire strands n | | | | | |
| | of the wire | | | | | |
| | groups | | | | | |
| | W/(d × n) × 100% | 99 | 107 | 107 | 107 | 107 |
| | G/d × 100% | 210 | 113 | 227 | 113 | 227 |
| | T/d × 100% | 200 | 133 | 133 | 133 | 133 |

| | | | | | |
|---|---|---|---|---|---|
| Presence/absence | Present | Present | Present | Present | Present |
| of belt cover layer | | | | | |
| Tire durability | 100 | 100 | 100 | 101 | 101 |
| performance | | | | | |
| Rolling resistance | 100 | 93 | 93 | 93 | 93 |

It is evident from Table 6 that, compared to the tire of Comparative Example 22, the tires of Working Examples 25 to 28 were able to reduce rolling resistance while maintaining excellent tire durability performance. Particularly, in Working Examples 25 to 28, rolling resistance was further reduced by configuring the wire strand diameter d of the monofilament steel wires to be less than that of the tires of Working Examples 21 to 24, and, because the belt cover layer pressed down on the monofilament steel wires of the belt layer, it was possible to maintain excellent tire durability performance

### REFERENCE NUMERALS

1 Tread portion
2 Side wall portion
3 Bead portion
4 Carcass layer
5 Bead core
6 Bead filler
7 Side reinforcing layer
8 Belt layer
9 Belt cover layer
10 Monofilament steel wires
11 Wire drawing mark
12 Wire group

What is claimed is:

1. A pneumatic tire comprising a reinforcing layer formed by aligning a plurality of monofilament steel wires with a circular cross-sectional shape and embedding said monofilament steel wires in rubber, wherein each of the monofilament steel wires is provided with twisting around an axis thereof without being crimped, and a wire surface twisting angle with respect to an axial direction of the monofilament steel wires is not less than 1°.

2. The pneumatic tire according to claim 1, wherein the wire surface twisting angle with respect to the axial direction of the monofilament steel wires is from 1° to 15°.

3. The pneumatic tire according to claim 1, wherein a wire strand diameter of the monofilament steel wires is from 0.20 mm to 0.50 mm.

4. The pneumatic tire according to claim 1, wherein a wire density of the monofilament steel wires in the reinforcing layer is from 50 wires/50 mm to 90 wires/50 mm.

5. The pneumatic tire according to claim 1, wherein the reinforcing layer is a belt layer, a belt cover layer, a carcass layer, or a side reinforcing layer.

6. A pneumatic tire comprising a belt layer disposed on an outer circumferential side of a carcass layer in a tread portion, the belt layer formed by aligning a plurality of monofilament steel wires with a circular cross-sectional shape and embedding said monofilament steel wires in rubber, wherein a wire strand diameter d of the monofilament steel wires is from 0.25 mm to 0.40 mm, a tensile strength S (MPa) of the monofilament steel wires has a relationship with the wire strand diameter d such that S≥3870−2000×d, each of the monofilament steel wires is provided with twisting around an axis thereof without being crimped, and a wire surface twisting angle with respect to an axial direction of the monofilament steel wires is not less than 1°.

7. The pneumatic tire according to claim 6, wherein the wire surface twisting angle with respect to the axial direction of the monofilament steel wires is from 1° to 15°.

8. The pneumatic tire according to claim 6, wherein a wire density of the monofilament steel wires in the reinforcing layer is from 50 wires/50 mm to 90 wires/50 mm.

9. The pneumatic tire according to claim 6, wherein a belt cover layer is wound on at least an outer circumferential side of an edge portion of the belt layer.

10. A pneumatic tire comprising a belt layer disposed on an outer circumferential side of a carcass layer in a tread portion, the belt layer formed by aligning a plurality of monofilament steel wires with a circular cross-sectional shape and embedding said monofilament steel wires in rubber, wherein each of the monofilament steel wires is provided with twisting around an axis thereof without being crimped, a wire surface twisting angle with respect to an axial direction of the monofilament steel wires is not less than 1°, a plurality of wire groups comprising from 2 to 4 of the monofilament steel wires is formed in the belt layer and, the monofilament steel wires are disposed in each of the wire groups so as to be aligned in a planar direction of the belt layer.

11. The pneumatic tire according to claim 10, wherein the wire surface twisting angle with respect to the axial direction of the monofilament steel wires is from 1° to 15°.

12. The pneumatic tire according to claim 10, wherein a wire strand diameter of the monofilament steel wires is from 0.20 mm to 0.40 mm.

13. The pneumatic tire according to claim 10, wherein a width of the wire groups is from 100% to 130% of a product of the wire strand diameter of the monofilament steel wires and a number of wire strands, and a spacing between the wire groups is from 70% to 250% of the wire strand diameter of the monofilament steel wires.

14. The pneumatic tire according to claim 10, wherein a thickness of the wire groups is from 100% to 150% of the wire strand diameter of the monofilament steel wires.

15. The pneumatic tire according to claim 10, wherein a wire density of the monofilament steel wires in the belt layer is from 50 wires/50 mm to 125 wires/50 mm.

16. The pneumatic tire according to claim 10, wherein a belt cover layer is wound on at least an outer circumferential side of an edge portion of the belt layer.

17. The pneumatic tire according to claim 1, wherein the reinforcing layer is a belt layer, and the pneumatic tire further comprises a belt cover layer, wherein the belt cover layer has a jointless structure and includes a strip material continuously wrapped in a circumferential direction of the tire, the strip material includes at least one reinforcing cord, and the reinforcing cord has at least one organic material fiber which is aligned and rubber coated.
